(19) United States
(12) Patent Application Publication
(10) Pub. No.: US 2023/0139920 A1
(43) Pub. Date: May 4, 2023

(54) METHOD FOR ESTIMATING PRECIPITATION DISTRIBUTION FOR A GEOGRAPHICAL REGION

(71) Applicant: BASF Agro Trademarks GmbH, Ludwigshafen am Rhein (DE)

(72) Inventors: Priyamvada SHANKAR, Köln (DE); Ole JANSSEN, Köln (DE); Fabian Johannes SCHAEFER, Langenfeld (DE); Andreas JOHNEN, Münster (DE); Christian KERKHOFF, Köln (DE); Xiangming ZENG, Durham, NC (US); Jared Wesley OYLER, Durham, NC (US); John MANOBIANCO, Durham, NC (US)

(21) Appl. No.: 17/917,783

(22) PCT Filed: Apr. 7, 2021
(86) PCT No.: PCT/EP2021/059119

§ 371 Date: Oct. 7, 2022

(30) Foreign Application Priority Data
Apr. 8, 2020 (EP) 20168734.0

(51) Int. Cl. G01W 1/10; G01W 1/14; A01B 79/00

(52) U.S. Cl. CPC G01W 1/10; G01W 1/14; A01B 79/005

(57) ABSTRACT

A method for estimating precipitation distribution for a geographical region comprising the steps of: providing precipitation data (S10) for the geographical region with a first spatial resolution for a predetermined period of time (t₁, t₂); providing first soil moisture data (S20) for the geographical region for a first point in time (t₃) with a second spatial resolution, wherein the second spatial resolution is higher than the first spatial resolution, and wherein the first point in time (t₃) is within the predetermined period of time (t₁, t₂); providing second soil moisture data (S30) for the geographical region for a second point in time (t₄) with a third spatial resolution, wherein the third spatial resolution is higher than the first spatial resolution, and wherein the second point in time (t₄) is within the predetermined period of time (t₁, t₂); calculating soil moisture difference data (S40) between the first soil moisture data and the second soil moisture data; calculating precipitation distribution data (S50) for the geographical region for the predetermined period of time (t₁, t₂) based on the precipitation data and the soil moisture difference data with a spatial resolution higher than the first spatial resolution.

### FIELD OF THE INVENTION

The present invention relates to a method for estimating precipitation distribution for a geographical region, a use of precipitation distribution data for providing a model for at least a part of the geographical region and a use of precipitation distribution data for providing agronomic management instructions for at least a part of the geographical region.

### BACKGROUND OF THE INVENTION

Agricultural management decisions such as timing, dosing and selection of planting date, crop protection measures, fertilizer application or harvesting operations are driven by environmental factors. In this respect, one major influential factor is the precipitation that happened in a specific field or even a specific field zone in the recent past, i.e. an infection event for a crop disease, e.g. Septoria, often depends on specific parameters of the precipitation, especially duration and amount of the precipitation, e.g. a heavy rainfall event within few minutes, may cause splash effects moving spores to higher leaf layers, while soft precipitation for several hours may cause improved spore germination conditions.

Current weather prediction, i.e. a prediction into the future and/or a prediction for a location between two weather stations, independent with respect to the time, commercially available in the market does often not give the precision and accuracy desired for agricultural purposes. For example, heavy precipitation during a thunderstorm event plays a significant role for agricultural management decisions, but such events often happen only very locally and often limited to very few hundred meters. However, commercially available precipitation prediction does not deliver that spatial resolution. Such commercially precipitation prediction is often provided with a resolution of only 1-km square or coarser using Numerical Weather Prediction (NWP) models to predict rain events, potentially altitude corrected.

In view of this, it is found that a further need exists to provide a method for estimating precipitation distribution for a geographical region at a higher resolution based on the data available.

### SUMMARY OF THE INVENTION

In the view of the above, it is an object of the present invention to provide a method for estimating precipitation distribution for a geographical region at a higher resolution based on the data available.

These and other objects, which become apparent upon reading the following description, are solved by the subject matter of the independent claims. The dependent claims refer to preferred embodiments of the invention.

According to the invention, a method for estimating precipitation distribution for a geographical region comprising the steps of:
providing precipitation data for the geographical region with a first spatial resolution (i.e. first unit of area) for a predetermined period of time (t₁, t₂); providing first soil moisture data for the geographical region for a first point in time (t₃) with a second spatial resolution (i.e. second unit of area), wherein the second spatial resolution is higher than the first spatial resolution, and wherein the first point in time (t₃) is within the predetermined period of time (t₁, t₂);
providing second soil moisture data for the geographical region for a second point in time (t₄) with a third spatial resolution (i.e. third unit of area), wherein the third spatial resolution is higher than the first spatial resolution, and wherein the second point in time (t₄) is within the predetermined period of time (t₁,t₂);
calculating soil moisture difference/residual data between the first soil moisture data and the second soil moisture data;
calculating precipitation distribution data for the geographical region for the predetermined period of time (t₁,t₂) based on the precipitation data and the soil moisture difference data with spatial resolution higher than the first spatial resolution.

In the context of the present invention, spatial resolution preferably refers to a grid, i.e. a linear spacing of a measurement or data point, and is indicated as number of measurement or data points per area (e.g. square meter). For example, the spatial resolution is indicated as “1 per 100 m²”.

In other words, the present invention proposes to use a known total amount of precipitation for a certain geographical region/are during a predetermined period of time provided with a low spatial resolution and to convert this total amount of precipitation into precipitation data with a high spatial resolution, wherein it is preferred that the soil moisture data and the precipitation data refers to identical geographical region, i.e. that the data are congruent. The first and second soil moisture data, which refer to different points in time and having a higher spatial resolution, are used to obtain soil moisture difference data/residual data. Notably, soil moisture data can be obtained rather easily by respective sensors. These soil moisture difference data are then used to convert the known total amount of precipitation for a geographical region into a higher spatial resolution. For converting the total amount of precipitation into a higher spatial resolution based on the soil moisture difference data, static statistical models or self-learning dynamic algorithms/machine learning algorithms can be used. It is noted that the present invention is not limited to the use of these methods for distributing the total amount of precipitation. In this respect, it is only important that the total amount of precipitation is converted into a higher spatial resolution based on the soil moisture difference data/residual data, i.e. on a comparison of both soil moisture data. This is because, in practice, it has been found that an accurate estimation of the precipitation distribution can be made in the light of such soil moisture difference data, i.e. that the total amount of precipitation provided with a lower spatial resolution can be accurately converted in the light of the soil moisture difference data into a higher spatial resolution. Notably, the term difference is to be understood broadly and is not limited to subtracting the respective values of both soil moisture data, but means that based on the comparison of both soil moisture data, the total amount of precipitation is distributed. As a result, the present invention can therefore provide a reliable and accurate estimation of the precipitation distribution in that geographical region based on the soil moisture data. However, the present invention is also not limited to estimate the precipitation distribution based on soil moisture data only. In practice, other parameters, i.e. supplementary data, may be additionally used to more accurately capture the relationship between soil moisture and precipitation, e.g. for a specific area. For instance, depending on a region's climate or a specific weather scenario, supplementary data may be added to the machine learning model to more accurately capture the relationship between soil moisture and precipitation for such a specific area. In an example, such additional data may include point-based weather station observations of precipitation and/or numerical weather model estimates of parameters important for representing water balance such as evapotranspiration, runoff, drainage, etc.

It is preferred that the calculation of the precipitation distribution data having a higher spatial resolution is based on the results of a machine-learning algorithm, e.g. neural networks. In other words, it is preferred that the precipitation distribution data having a low spatial resolution and the first and second soil moisture data having a high spatial resolution are fed to one or more trained machine-learning algorithm to distribute the total amount of precipitation resulting in the precipitation distribution data with a high spatial resolution. For example, such machine-learning algorithm can be trained on a specific geographical region and its specifics and then be used to distribute the total amount of precipitation in that geographical region, whereby it is then only necessary to input the precipitation data and the first and second soil moisture data (or the soil moisture difference data) into the machine-learning algorithm.

Notably, it has been shown that in certain geographical regions, a similar distribution of precipitation for different rainfall events occur. In such cases, a distribution scheme can be used several times, i.e. in such a case, it is not necessary to provide new soil moisture data to distribute the total amount, but a once determined ratio can be used repeatedly or a trained neuronal network can downscale/distribute the provided precipitation data even if no recent soil moisture data are provided. Thus, in such cases the estimation of the precipitation distribution can be obtained only by using the precipitation data for estimating the precipitating distribution.

The machine-learning algorithm preferably comprises decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data.

It is preferred that the precipitation data are remotely sensed historical precipitation data or weather forecast data, preferably comprising the total amount of precipitation and the duration of precipitation in hourly resolution, e.g. data points are provided and/or updated at least once in an hour. In this respect, it is possible that the weather forecast data are derived from the Global Forecast System (GFS). However, it has to be noted that the present invention is not limited to specific weather forecast data. The weather forecast data can be weather forecast data from the near past or current weather forecast data relating to the near future. Which weather forecast data are used depends on whether the current precipitation distribution in the geographical regions should be estimated or the precipitation distribution in the near future should be estimated.

Alternatively or additionally, the precipitation data can also be calculated based on cloud distribution data and cloud surface temperature data. In this respect, it is preferred that the data of geostationary satellites or stationary terrestrial weather radar data is used.

It is further preferred that the second spatial resolution and the third spatial resolution are equal, preferably 100-meter square grid. In practice, it has been shown that particularly good estimation results can be achieved, if the first and second soil moisture data have the same spatial resolution and preferably the same spatial position.

Furthermore, it is preferred that the ratio between the first spatial resolution and the second spatial resolution is between 1:15 and 1:5, preferably between 1:12 and 1:7 and is most preferably 1:10, wherein the first spatial resolution is preferably a 1-kilometer square grid and the second and the third spatial resolution is preferably 100-meter square grid. Here, too, it has been shown that particularly good estimation results can be achieved with such conversion ratios of the resolutions. It is preferred that the first point in time (t₃) is near the end of the predetermined period of time. In this respect, it is preferred that the first point in time (t₃) is in a range between 0 to 10 hours, preferably between approximately 0 to 5 hours and most preferably approximately 0 hours prior to the end (t₂) of the predetermined period of time (t₁, t₂) and/or the second point in time (t₄) is between 20 to 30 hours, preferably 23 to 26 hours and most preferably 24 hours prior to the end (t₂) of the predetermined period of time (t₁, t₂). Moreover, it is preferred that the predetermined period of time is a 24-hour period. In practice, it has been shown that particularly good estimation results can be achieved with this selection of points in time as well. However, the present invention is not limited to these preferred predetermined period of time and/or the preferred first and/or second point in times.

The present invention further relates to a use of precipitation distribution data as described above for calculating one of the following models for at least a part of the geographical region: nutrient management model; navigation model; disease model and/or a pathogen model.

In addition, the present invention relates to a use of precipitation distribution data calculated as described above for determining one of the following agronomic management instructions for at least a part of the geographical region: nutrient management instructions; navigation instructions; disease treatment instructions and/or pathogen treatment instructions. Furthermore, the present invention also relates to a use of precipitation distribution data calculated as described above for providing control data for at least one agricultural equipment. Moreover, the present invention relates to an agricultural equipment configured to be controlled by such control data. The present invention also relates to a system for estimating precipitation distribution for a geographical region, comprising:
at least one processing unit configured to receive precipitation data for the geographical region with a first spatial resolution for a predetermined period of time (t₁, t₂);
at least one processing unit configured to receive first soil moisture data for the geographical region for a first point in time (t₃) with a second spatial, wherein the second spatial resolution is higher than the first spatial resolution, and wherein the first point in time (t₃) is within the predetermined period of time (t₁, t₂);
at least one processing unit configured to receive second soil moisture data for the geographical region for a second point in time (t₄) with a third spatial resolution, wherein the third spatial resolution is higher than the first unit of area, and wherein the second point in time (t₄) is within the predetermined period of time (t₁, t₂);
at least one processing unit configured to calculate soil moisture difference data between the first soil moisture data and the second soil moisture data;

at least one processing unit configured to calculate precipitation distribution data for the geographical region for the predetermined period of time (t₁, t₂) based on the precipitation data and the soil moisture difference data with a spatial resolution higher than the first spatial resolution.

Finally, the present invention also relates to a computer program element which when executed by a processor is configured to carry out the above explained method for estimating precipitation distribution for a geographical region.

The computer program element might be stored on a computer unit, which might also be part of an embodiment. This computing unit may be configured to perform or induce performing of the steps of the methods described above. Moreover, it may be configured to operate the components of the above described apparatus and/or system. The computing unit can be configured to operate automatically and/or to execute the orders of a user. A computer program may be loaded into a working memory of a data processor. The data processor may thus be equipped to carry out the method according to one of the preceding embodiments.

This exemplary embodiment of the invention covers both, a computer program that right from the beginning uses the invention and computer program that by means of an update turns an existing program into a program that uses invention.

Further on, the computer program element might be able to provide all necessary steps to fulfill the procedure of an exemplary embodiment of the methods as described above.

According to a further exemplary embodiment of the present invention, a computer readable medium, such as a CD-ROM, USB stick or the like, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

### BRIEF DESCRIPTION OF THE DRAWINGS

In the following, the invention is described exemplarily with reference to the enclosed figure, in which

FIG. 1 is a schematic overview of a method for estimating precipitation distribution according to the preferred embodiment of the present invention;

FIG. 2 is an example for precipitation data for a geographical region provided with a 1-km-resolution fora predetermined period of time (t₁, t₂);

FIG. 3a is an example for first soil moisture data for the geographical region for a first point in time (t₃) with a 100-m resolution;

FIG. 3b is an example for second soil moisture data for the geographical region for a second point in time (t₄) with a 100-m resolution;

FIG. 4 is an example for soil moisture difference data;

FIG. 5 is an example for precipitation distribution data for the geographical region for the predetermined period of time (t₁, t₂) based on the precipitation data and the soil moisture difference data with a 100-m resolution;

FIG. 6 is a schematic overview of the different agronomic management models using precipitation distribution data; and

FIG. 7 is a schematic overview of the different agronomic management instructions using precipitation distribution data.

### DETAILED DESCRIPTION OF EMBODIMENT

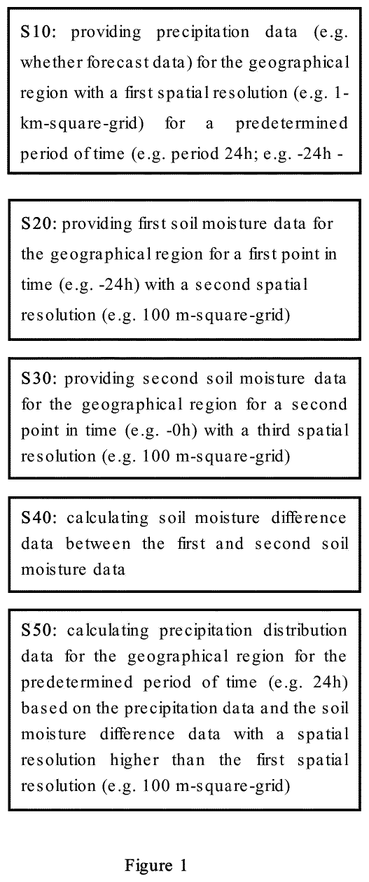

FIG. 1 is a schematic overview of a method for estimating precipitation distribution according to the preferred embodiment of the present invention. In the following, an exemplary order of the steps according to the preferred embodiment of the present invention is explained.

In a step S10, precipitation data for a geographical region with a low resolution for a predetermined period of time are provided, e.g. these precipitation data can be provided by weather forecast services, like the Global Forecast System (GFS) using atmospheric models to predict rain events. The precipitation data can also be provided as remotely sensed historical precipitation data. Alternatively or additionally, the precipitation data can also be calculated based on cloud distribution data and cloud surface temperature data. In this respect, it is preferred that the data of geostationary satellites or stationary terrestrial weather radar data is used.

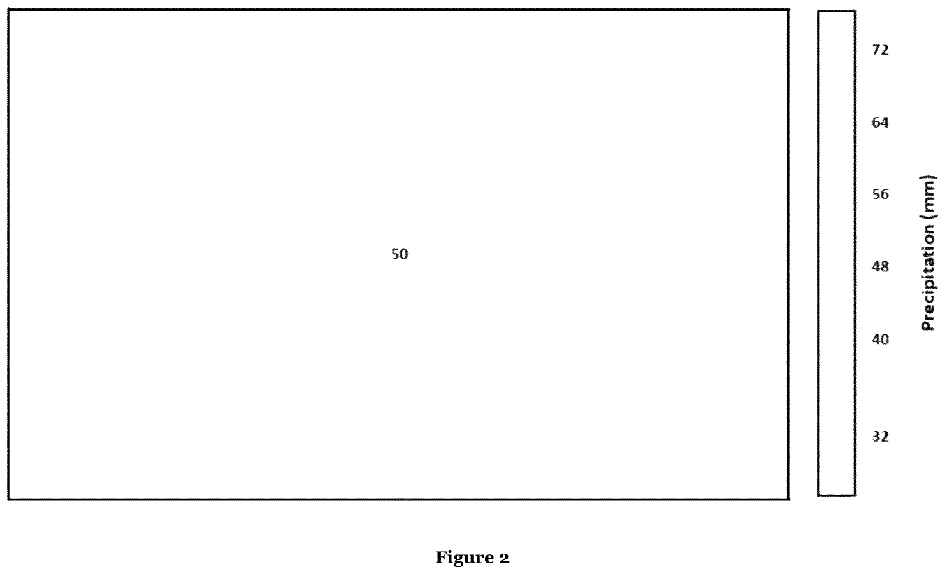

The resolution of the precipitation data is preferably 1-kilometer square grid. The predetermined period of time is preferably a time window of the last 24 hours, i.e. t₁ is 24 hours back and t₂ is the current time. By such a choice of the time window, the present precipitation distribution in the geographical region can be determined with the preferred embodiment of the present invention. In this context, it should be noted that the present invention is not limited to the determination of the present precipitation distribution, but that a respective time window for which the weather forecast data are to be obtained also allows a future-oriented providing of the precipitation distribution, e.g. when t₁ is the current time and t₂ is 24 hours in the future. In FIG. 2, an example for such precipitation data for a geographical region for an area of one square kilometer for a time window of 24 hours is shown, wherein in this example a precipitation of 50 mm occurred.

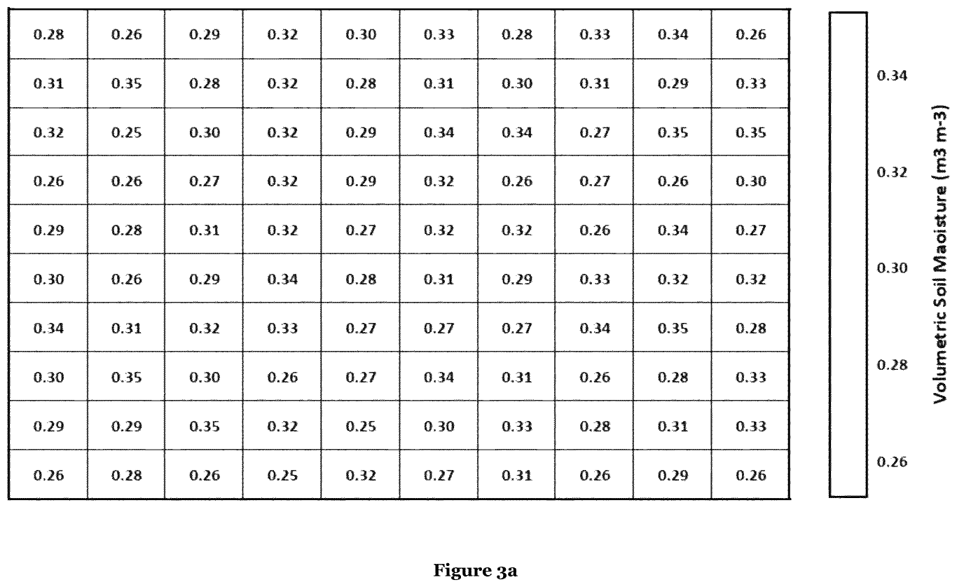

In steps S20 and S30, first and second soil moisture data for the geographical region for two points in time are provided, wherein these soil moisture data are provided with higher resolutions compared to the resolution of the precipitation data. In this respect, it is preferred that the second spatial resolution and the third spatial resolution are equal and preferably a 100-meter square. Notably, the respective soil moisture values of the soil moisture data may be provided in any measuring unit, e.g. as shown in FIGS. 3a and 3b in cubicmeter water/fluid per cubicmeter soil. In FIGS. 3 shows examples of such soil moisture data, which were provided with a 100-meter resolution. In this example, FIG. 3a shows the first soil moisture data for a point in time t₃ (e.g. the current time; t₂−0 hours), wherein FIG. 3b shows the second soil moisture data for a point in time t₄ (e.g. t₂−24 hours). For instance, if the precipitation value in FIG. 2 represents the precipitation that fell from Apr. 5, 2020 (T00:00) to Apr. 6, 2020 (T00:00), FIGS. 3a and 3b preferably represent snapshots of the soil moisture at or near the beginning, i.e. t₄=Apr. 5, 2020 (T00:00) and end, i.e. t₃=Apr. 6, 2020 (T00:00) of the precipitation time period.

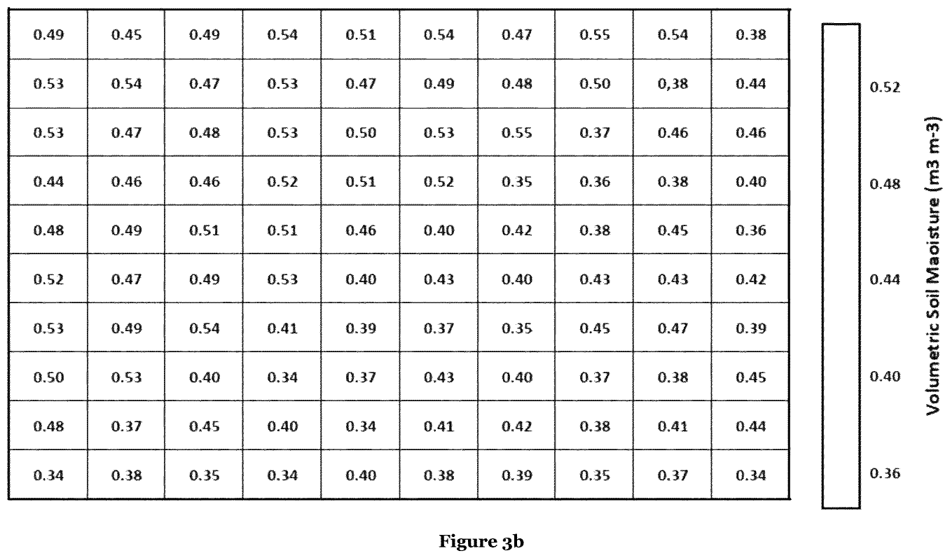

In a step S40, soil moisture difference data, i.e. residual data, between the first soil moisture data and the second soil moisture data is calculated. The latter can be done, for example, by calculating a difference between the second data and the first data. Based on this soil moisture difference data the precipitation distribution data for the geographical region can be calculated/estimated in a step S50. In an embodiment of the invention, the precipitation distribution data having a low resolution and the first and second soil moisture data having a high resolution can be fed to one or more trained machine-learning algorithm to distribute the total amount of precipitation and to provide precipitation distribution data with a high resolution. For example, such machine-learning algorithm can be trained on a specific geographical region and its specifics and then be used to distribute the total amount of precipitation in that geographical region, whereby it is then only necessary to input the precipitation data and the first and second soil moisture data into the machine-learning algorithm. In FIG. 4, an example for such soil moisture difference data is shown based on the first and second soil moisture data shown in FIGS. 3.

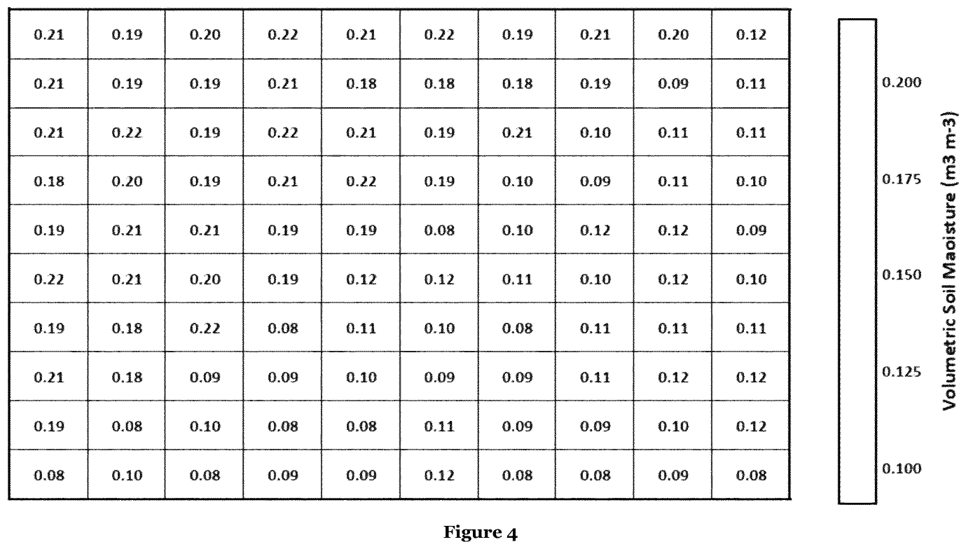

FIG. 5 is an example for precipitation distribution data for the geographical region for the predetermined period of time (t₁ , t₂ ) based on the precipitation data and the soil moisture difference data with a spatial resolution higher than the first unit of area. The amount of rainfall was distributed over the geographical region according to the distribution of soil moisture difference data.

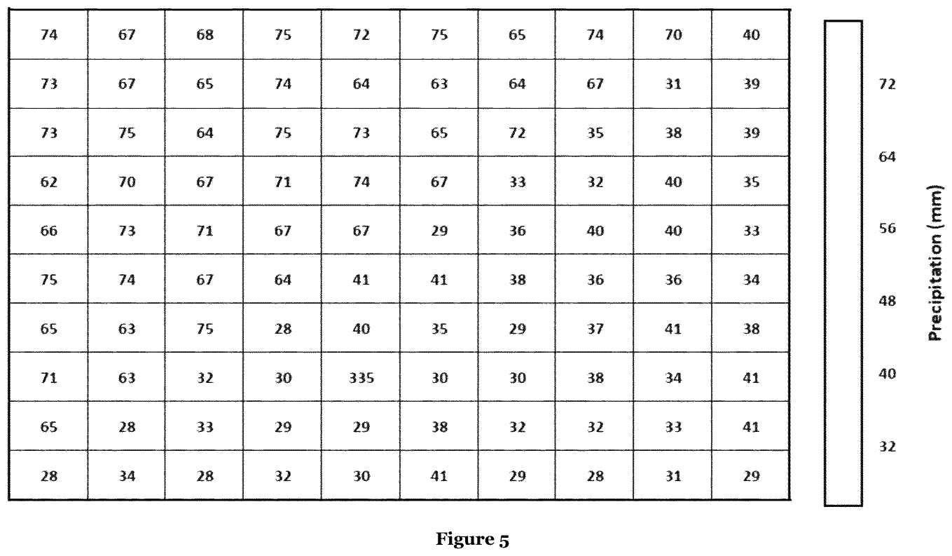

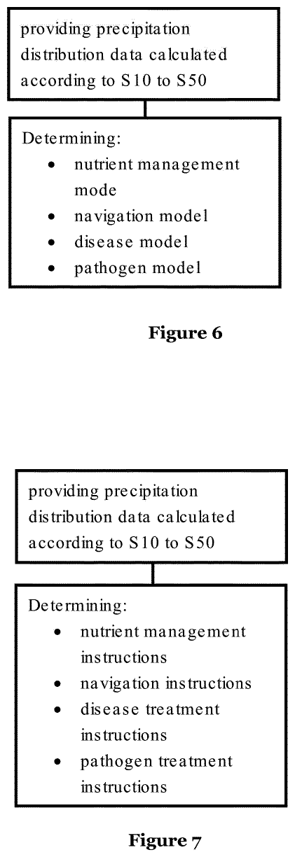

FIG. 6 shows a schematic overview of the different agronomic management models using precipitation distribution data provided according to the above described method. FIG. 7 is a schematic overview of the different agronomic management instructions using precipitation distribution data provided according to the preferred embodiment of the present invention.

The present invention has been described in conjunction with a preferred embodiment as examples as well. However, other variations can be understood and effected by those persons skilled in the art and practicing the claimed invention, from the studies of the drawings, this disclosure and the claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A method for estimating precipitation distribution for a geographical region comprising:
providing precipitation data (S10) for the geographical region with a first spatial resolution for a predetermined period of time (t₁, t₂);
providing first soil moisture data (S20) for the geographical region for a first point in time (t₃) with a second spatial resolution, wherein the second spatial resolution is higher than the first spatial resolution, and wherein the first point in time (t₃) is within the predetermined period of time (t₁, t₂);
providing second soil moisture data (S30) for the geographical region for a second point in time (t₄) with a third spatial resolution, wherein the third spatial resolution is higher than the first spatial resolution, and wherein the second point in time (t₄) is within the predetermined period of time (t₁, t₂);
calculating soil moisture difference data (S40) between the first soil moisture data and the second soil moisture data; and
calculating precipitation distribution data (S50) for the geographical region for the predetermined period of time (t₁, t₂) based on the precipitation data and the soil moisture difference data with a spatial resolution higher than the first spatial resolution.

2. The method according to claim 1, wherein the precipitation data are remotely sensed historical precipitation data or weather forecast data.

3. The method according to claim 1, wherein the precipitation data are calculated based on cloud distribution data and/or cloud surface temperature data.

4. The method according to claim 3, wherein the cloud distribution data and/or cloud surface temperature data are obtained by using geostationary satellites or stationary terrestrial weather radar data.

5. The method according to claim 1, wherein the second spatial resolution and the third spatial resolution are equal.

6. The method according to claim 1, wherein the ratio between the first spatial resolution and the second spatial resolution is between 1:15 and 1:5.

7. The method according to claim 1, wherein the first point in time (t₃) is between 0 to 10 hours and/or the second point in time (t₄) is between 20 to 30 hours.

8. The method according to claim 1, wherein the predetermined period of time is a 24-hour period.

9. The method according to claim 1, further comprising calculating one of the following models for at least a part of the geographical region:
nutrient management model;
navigation model;
disease model; and
pathogen model.

10. The method according to claim 1, further comprising determining one of the following agronomic management instructions for at least a part of the geographical region:
nutrient management instructions;
navigation instructions;
disease treatment instructions; and
pathogen treatment instructions.

11. The method according to claim 1 further comprising providing control data for at least one agricultural equipment.

12. Agricultural equipment configured to be controlled by control data at least based on precipitation distribution data calculated according to a method according to claim 1.

13. A system for estimating precipitation distribution for a geographical region, the system comprising:
at least one processing unit configured to receive precipitation data (S10) for the geographical region with a first spatial resolution for a predetermined period of time (t₁, t₂);
at least one processing unit configured to receive first soil moisture data (S20) for the geographical region for a first point in time (t₃) with a second spatial resolution, wherein the second spatial resolution is higher than the first spatial resolution, and wherein the first point in time (t₃) is within the predetermined period of time (t₁, t₂);
at least one processing unit configured to receive second soil moisture data (S30) for the geographical region for a second point in time (t₄) with a third spatial resolution, wherein the third spatial resolution is higher than the first spatial resolution, and wherein the second point in time (t₄) is within the predetermined period of time (t₁, t₂);
at least one processing unit configured to calculate soil moisture difference data (S40) between the first soil moisture data and the second soil moisture data; and
at least one processing unit configured to calculate precipitation distribution data (S50) for the geographical region for the predetermined period of time (t₁, t₂) based on the precipitation data and the soil moisture difference data with a spatial resolution higher than the first spatial resolution.

14. A non-transitory computer readable medium having instructions encoded thereon that when executed by a processor cause the processor to carry out the method according to claim 1.
